(19) United States
(12) Patent Application Publication
(10) Pub. No.: US 2008/0154871 A1
(43) Pub. Date: Jun. 26, 2008

(54) Method and Apparatus for Mobile Information Access in Natural Language

(75) Inventors: Jochen Leidner, Edinburgh (GB); Tiphaine Dalmas, Edinburgh (GB)

Correspondence Address: POTOMAC PATENT GROUP PLLC, P. O. BOX 270, FREDERICKSBURG, VA, 22404, US

(73) Assignee: Linguit Ltd., Edinburgh (GB)

(21) Appl. No.: 11/815,571

(22) PCT Filed: Feb. 6, 2005
(86) PCT No.: PCT/EP05/01198

§ 371 Date: Nov. 7, 2007

(51) Int. Cl. G06F 7/06

(52) U.S. Cl. 707/4; 707/E17.136

(57) ABSTRACT

This patent describes a method for mobile information access, executed in a networked computer system comprising at least a mobile information access server and one or a plurality of information retrieval systems, comprising the steps of: receiving a message from a mobile communication device; analyzing the received message; forming one or a plurality of queries based on the message analysis; obtaining documents based on the one or the plurality of queries; extracting candidate answers from the documents; validating candidate answers; composing an answer summary; sending the answer summary back to the mobile communication device, wherein the answer summary is limited to a predetermined size. The patent also describes an apparatus for mobile information access.

### FIELD OF THE INVENTION

The invention relates to a method and an apparatus for mobile information access using mobile communication devices. More particularly, it relates to a method and an apparatus for mobile information access using small mobile communication devices having restricted capabilities for receiving and outputting the accessed information.

### BACKGROUND & PRIOR ART

Besides providing a practical means for personal, human-to-human communication, one further application of mobile communication devices is to provide a user with the ability to satisfy her or his information needs by accessing remote information sources hosted on a machine.

One important example is using the mobile communication device to search for information.

Important constraints on the effectiveness of mobile communication devices for this purpose of searching for information are that:
the transmission of large quantities of data is slow due to limited channel capacities;
the format imposed by messaging protocols for sending messages between the mobile communication device and the information provider is limited, e.g. to 160 characters for short text messages (SMS);
keyboards of mobile communication devices are small and cumbersome to use when inputting text;
on the output side, mobile phones or other devices usually carry only a very small display for displaying information to the user.

Limitations in transmission capacity as well as message, keyboard and display size generally require that also search queries and responses must be limited in size. Regarding search queries, the user must be able to provide very short and concise queries. Regarding responses, the responding system must be able to generate very concise and relevant responses.

Conciseness of queries and responses may be achieved by domain-specific systems that allow only a very limited, defined range of queries and provide access to pre-structured data. This is sufficient in situations/domains in which the set of possible queries is well-known and queries posses a well-known structure. If the query is well-known, a lookup in a cache or in a specialized database engine is usually sufficient to retrieve the exact and relevant response. One example of this approach are queries about train timetables, which can be recognized and parsed into a simple template (departure, destination, time) and information can be retrieved with good accuracy from a structured database.

Domain-specific information retrieval systems are described in Gallwitz, F., M. Aretoulaki, M. Boros, J. Haas, S. Harbeck, R. Huber, H. Niemann, and E. Noth, “The Erlangen Spoken Dialogue System EVAR: A State-of-the-Art Information Retrieval System” (In Proceedings of 1998 International Symposium on Spoken Dialogue (ISSD 98), pages 19-26, Sydney, Australia, November 1998), Huang, Xuedong, Alex Acero and Hsiao-Wuen Hon (2001), “Spoken Language Processing: A Guide to Theory, Algorithm and System Development”, Prentice Hall PTR and Young, S. (2002). “The Statistical Approach to the Design of Spoken Dialogue Systems.” Tech Report CUED/F-INFENG/TR.433, Cambridge University Engineering Department.

However, the domain-specific approach is usually not very flexible with regard to the queries that can be handled. Moreover, it is costly to implement and it usually covers only a very limited field of interest.

Alternatively, and in particular if the query's domain is not well-known, a second approach may be used. This is usually an open-domain or more usually hybrid (domain-specific and open-domain) approach: with little understanding of the query and knowledge about its domain, it is still attempted to retrieve a relevant response by parsing the results.

Recently, this second approach has received increased attention, due to the vast amounts of information that is freely available on the Internet in the form of hypertext documents. In that context, any search engine that is accessible via the World Wide Web (WWW) can also be accessed via mobile phones using WAP (Wireless Access Protocol). Examples are the keyword based ‘Google Wireless’ search service (http://www.google.com/options/wireless.html) and the keyword based ‘Yahoo! Mobile’ search service (http://mobile.yahoo.com/search), both via WAP.

However, if input and output are not specifically adapted to the mobile context, usage may be quite cumbersome. Search for information in the mobile space is currently a two-step process: a user first has to find out where he or she can obtain information from, and in a second step go there and satisfy the information need proper.

On the desktop, the first step is usually performed using a keyword based Internet search engine (like Google or Yahoo, for example), which returns a list of hyperlinks that are addresses where the information itself can be found. The large size of the desktop screen makes keyword-based search effective on the desktop because many results can be presented. This process even works when not all results are relevant. Users manually go seemingly relevant sites with a mouse-click, and if the Web site seems to be containing the information sought, they browse to find it, which is complex since many further steps are involved.

In a mobile scenario, on the other hand, navigation is much harder due to the absence of a mouse, and a much smaller screen, which requires many more manual navigational steps (such as scrolling, turning pages etc.). Therefore, it is not sufficient to merely emulate the desktop mechanism on a mobile communication device.

Hence, the query and response mechanisms must be adapted to better suit the needs of mobile users when accessing web-based query-response systems, e.g. search engines.

One approach is described in J.-D. Ruvini, “Adapting to the user's internet search strategy on small devices” (in: Proceedings of the 8th International Conference on Intelligent User Interfaces, Miami, Fla., USA, p. 284-286, 2003), which presents a front-end to the Google Search Engine for mobile phones offering web browsing.

Another approach is keyword based Google SMS search via SMS (http://www.google.com/sms).

Here, coverage is usually larger than in the top-down approach, however, relevance and accuracy of the response is harder to achieve due to the unstructured nature of the underlying data. As a consequence, several short messages may have to be sent to ensure that a relevant answer is included, requiring increased storage capacity on the mobile communication device and cumbersome for the user to read. However, even then the receipt of a relevant answer is not certain.

### OBJECTS OF THE INVENTION

It is therefore an object of the present invention to adapt the composition of the response such that it satisfies the resource limitations of current mobile devices, while at the same time retaining/obtaining a high relevance of the answer, i.e. to ensure a high probability that the response contains the correct answer to the question.

It is another object of the present invention to increase the usability of a mobile query-response system.

### SUMMARY OF THE INVENTION

These objects are achieved according to the invention by a mobile information access method according to independent claim 1 and by an apparatus for mobile information access according to independent claim 15. Advantageous embodiments are defined in the dependent claims.

By providing an interface for posing queries as natural language questions or linguistic phrases and using linguistic tools to analyze them, the relevance of search results is increased and therefore the size of the response may be decreased accordingly, malting it possible to provide the user with a relevant answer despite the resource limitations of his mobile communication device.

By additionally providing a user profile, the mobile communication device or the user is known to the system or identifiable via the identification number, further serving to increase the relevance of an automatically provided answer for that particular user, in particular because of an inherent knowledge of the device's parameters. Moreover, the user profile does also ensure a positive user experience by virtue of using information about the user and his or her mobile communication device, without requiring re-entry of this profile information, and by virtue of utilizing such prior contextual knowledge to constrain the number of candidate answers considered (step 650) to a set that is more likely to be relevant to the user.

The interface for posing natural language questions according to this claim provides unified access to structured and unstructured information sources.

Further characteristics and advantages will become apparent when reading the following detailed description with reference to the annexed figures.

### BRIEF DESCRIPTION OF THE FIGURES

FIG. 1 is a schematic view of an example system in which the method for mobile information access is executed on a mobile information access server according to the present invention.

FIG. 2 shows a schematic view of an embodiment of a method for mobile information access according to the present invention.

FIG. 3 shows the analysis of a message in an embodiment of the method for mobile information access according to the present invention.

FIG. 4 shows details of the linguistic analysis of a question extracted during the analysis of a message shown in FIG. 3.

FIG. 5 shows the linguistic processing of query responses in an embodiment of the method for information retrieval according to the present invention.

FIG. 6 shows a schematic view of another embodiment of a method for mobile information access according to the present invention.

FIG. 7 shows a table of possible user profile contents used in the embodiment of the invention described in FIG. 2.

FIG. 8 shows an exemplary output of a method for mobile information access according to the present invention.

FIG. 9 shows an embodiment of an apparatus for mobile information access according to the present invention.

### DETAILED DESCRIPTION OF THE INVENTION

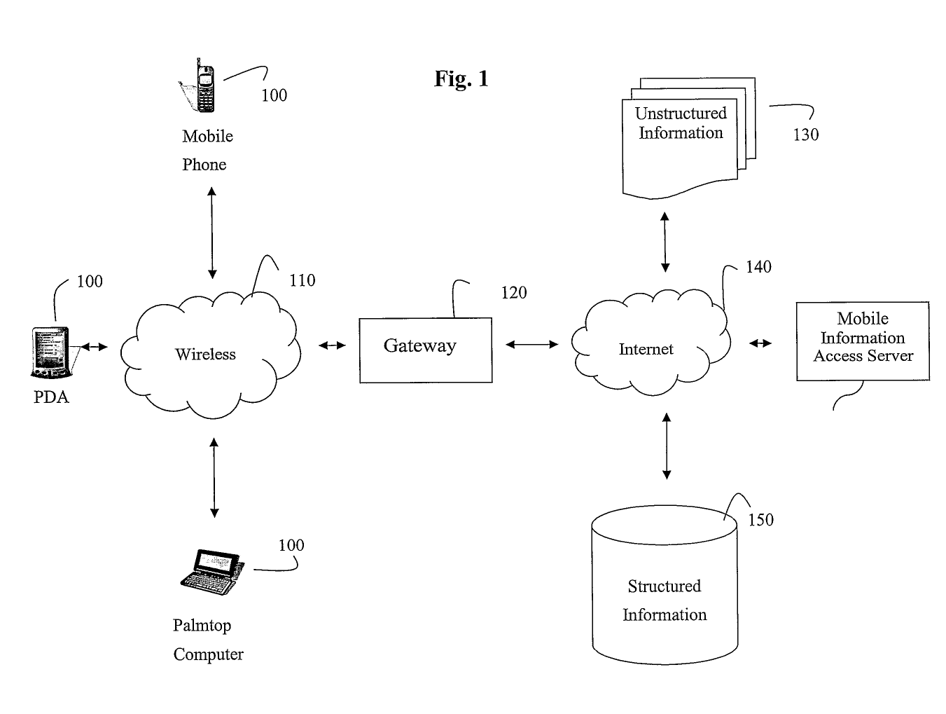

FIG. 1 is a schematic view of an example system in which the method for mobile information access is executed on a mobile information access server according to the present invention.

In FIG. 1, reference sign 100 designates mobile communication devices, e.g. a cell phone, a smart phone, a Personal Digital Assistant (PDA), a wearable device etc.

Each mobile communication device 100 communicates over a wireless communication network 110, such as a telephone network or a wireless LAN, a gateway 120 and the Internet 140 with a mobile information access server 160 according to the invention. The gateway 120 bridges communication from the wireless communication network 110 to the Internet 140 and vice versa.

The mobile information access server 160 is connected to one or a plurality of unstructured data sources 130 providing unstructured data as well as to one or a plurality of structured data sources 150 providing structured data.

Unstructured data sources may include, but are not limited to, locally indexed full-text collections, Intranet retrieval engines and especially Internet/Web search engines.

Structured data sources may include, but are not limited to Simple Online Access Protocol (SOAP) Web Services, relational databases or semi-structured XML repositories (such as indexed Resource Description Format (RDF) data and Real Simple Syndication (RSS) streams.

Not shown in FIG. 1 but also present in the example system in which the method for mobile information access is executed on a mobile information access server according to the present invention is a multitude of document servers connected to the Internet, providing documents e.g. in the form of HTML (Hypertext Markup Language) pages, which are indexed e.g. by the Internet Search Engines 130.

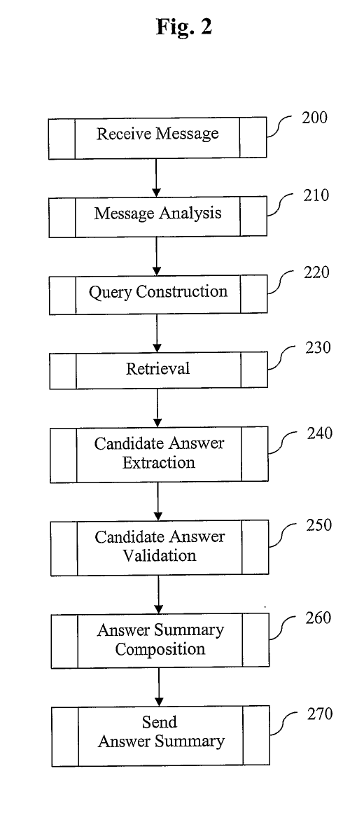

FIG. 2 shows a schematic view of an embodiment of a method for mobile information access according to the present invention.

In step 200, a message originating from a mobile communication device 100 is received by a mobile information access server 160.

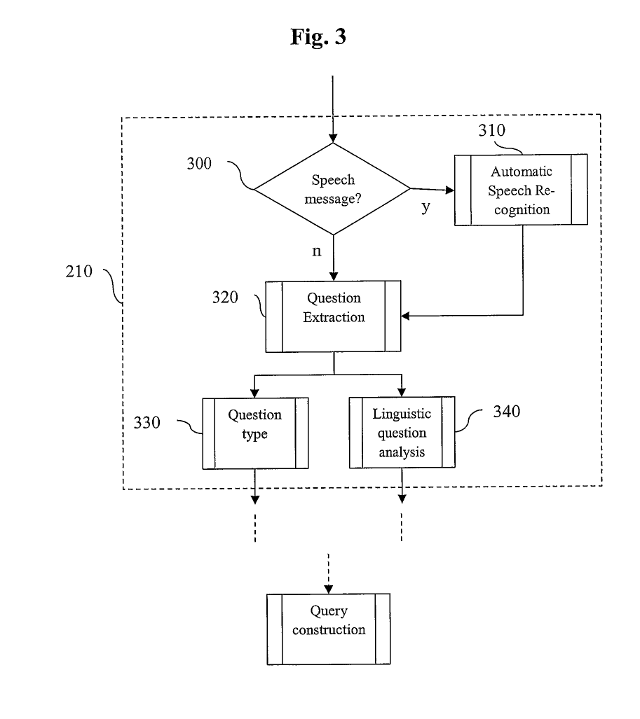

In step 210, the received message is analyzed; in particular a question or a linguistic phrase in natural language is extracted from the query. Details of the analytical process will subsequently be described with reference to FIG. 3 below. Linguistic phrases like ‘Restaurant in Edinburgh’ will be treated like questions. They may be assigned a default question type.

In step 220, a query is constructed based on the question or phrase that was extracted from the message and based on the subsequent analysis in step 210. First, a set of keywords and key phrases are derived as basic search engine query constituents. These are then expanded with question type specific and domain specific keywords, taking into account individual idiosyncrasies in document search engine syntax.

In addition, restriction operators may be added to the search engine query so as to focus it on a set of topic-related documents or websites, and such a topic-specific search is merged with a general search.

In step 230, information is retrieved from structured and unstructured data sources in the form of Web pages, database tuples or XML trees. The queries obtained in step 220 are executed against the respective search engines, e.g. Google, Yahoo! or MSN Search and structured information sources like databases.

Since the lists of document identifiers or links provided by the document search engines might already be viewed as the required documents, because they often provide relevant information together with the document identifiers, in the form of so-called ‘snippets’. These documents can thus either be directly digested or the server downloads documents referenced by the search engine results and analyzes/digests these downloaded documents. In one embodiment of this invention, all further processing is carried out on the search engine summary snippets. In another embodiment, a constant number of document identifiers are (e.g. hyperlinks) are retrieved from the search engine, and the documents referred to are downloaded.

After obtaining the results from the unstructured and the structured data sources, they are merged.

In step 240, the retrieval result is analyzed using text analysis in order to designate candidate answers. Candidate answers are extracted from the documents obtained in step 230, using information from text analysis and the above-described question analysis.

In step 250 the candidate answers are validated, i.e. filtered and ranked in order of decreasing plausibility/answer-likelihood. Candidate answers are ranked according to relative criteria (answer a better than answer b) to reflect answer likelihood.

In step 260, an answer summary is composed from top n candidate components, taking into account the requirement to limit the output to a predetermined size. The predetermined size may depend on the size of the display of the output device, the maximal size of singular text messages or individual user preferences. Depending on the predetermined size and the number of retrieved candidate answer fragments n that exceed a minimal confidence threshold, a number c=f(s, n) of candidate answers A1, A2, . . . , AN 215 are considered and merged together, possibly formatted or separated by a special sigil (such as a line or a separator character like ‘/’) to form an answer summary.

The answer summary is sent back to the mobile unit (108). Optionally, the answer summary can be transformed into speech by a speech synthesis unit.

FIG. 3 shows step 210 for doing message analysis in greater detail.

Message analysis is used to generate the query, with which the search engine will be fed, classify the question into a broad but known category or question type and generate keyword lemmata to be used later in the pipeline.

In step 300, it is first determined whether the message is originated by the mobile communication device 100 in the form of spoken language. In that case, it will be subjected to Automatic Speech Recognition (ASR) in step 310.

In step 320, the question or phrase is extracted from the message. Once the question or phrase is isolated, it is subject to further analysis in order to be able to understand the question or phrase or at least to be able to draw certain inferences on the kind of answer that is expected.

In step 330, the question or phrase type (what type of information is sought?) is computed, using a linguistic question type model. Since the question ‘When was Galileo born?’ is seeking temporal information, its answer cannot be the name of a person. The question or phrase focus (entity about which information is sought) is also derived (Galileo, in this example).

In step 340, the question text is used to analyze the question linguistically, using a (set of) linguistic model(s), including part-of-speech (POS) tagging, stemming, lemmatization, chunking, named entity tagging, word sense disambiguation and toponym resolution.

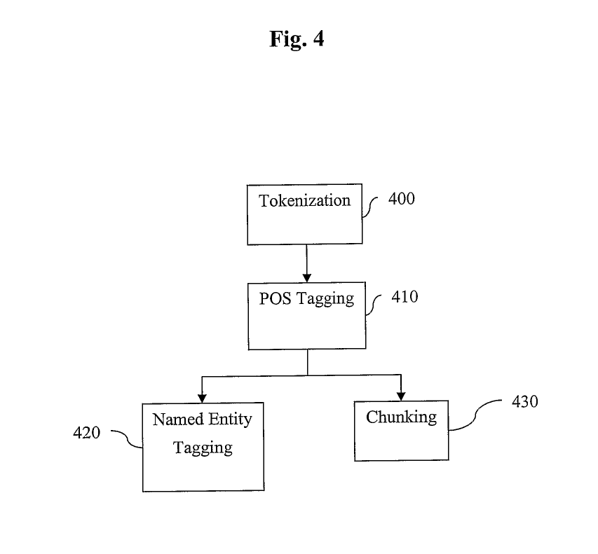

FIG. 4 shows details of the linguistic analysis of a question extracted during the analysis of a message shown in FIG. 3.

Tokenization (Step 400) splits the question into tokens. Lemmatization (not shown) generates the canonical form of a word, e.g. the term “are” generates “be”.

POS-Tagging (Step 410) labels tokens with grammatical tags, e.g. the term “large” with JJ for adjective.

Named Entity Tagging recognizes and categorizes classes of proper nouns, e.g. names of persons or names of locations, dates and times, etc.

Chunking is the recognition and classification of non-recursive syntactic phrases, e.g. verb group, noun group, propositional group.

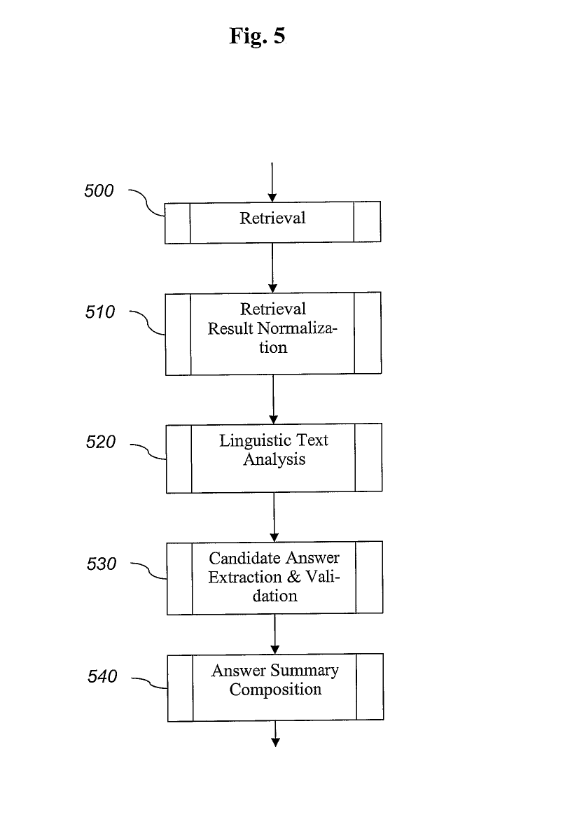

FIG. 5 shows the linguistic processing of retrieval results in an embodiment of the method for mobile information access according to the present invention.

In step 510, the results of the retrieval may be normalised, i.e. the text may have to be separated from meta-data pertaining to the retrieval engines, or converted from a specific format (e.g. HTML) to plain text.

In step 520, a similar analysis is performed as shown in FIG. 4 and described above, now on the normalised retrieval results.

In step 530, all units of text that are compatible with the Question Type Unit (e.g., “February 14” is a date, which is compatible with a “when”-question, and “Isabelle” is a name, which is compatible with a “who” question), and validated/ranked according to their likelihood of being answers to the question, resulting in a score called ‘rank’ taking into account the linguistic context given by the result of the linguistic analysis of the context of the document that the answer candidate was extracted from and the result of the linguistic Question Analysis Unit.

The N answer candidates with the highest rank are used as input in the answer summary composition step 540, where an answer summary is composed, taking into account the message size constraints and other properties retrieved from the user profile.

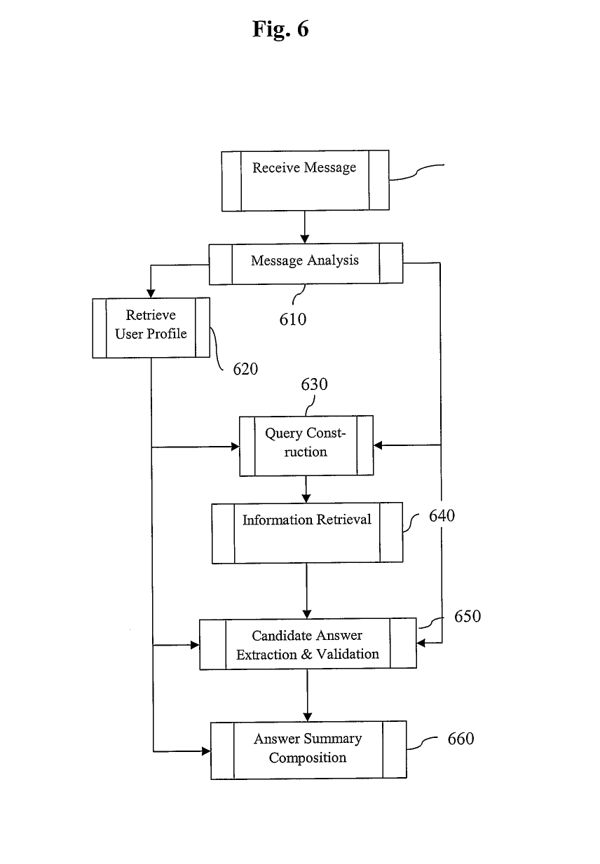

FIG. 6 shows a further embodiment of the mobile information access method of the present invention. The following description will concentrate on the specific differences to the method shown in FIG. 2.

In this embodiment, the message also comprises an identifier in order to identify the mobile communication device based on the received message, e.g. a telephone number, which is extracted and stored in step 610.

In step 620 this identifier for the mobile communication device from which the message originated is used to retrieve a user profile.

The user profile is consulted to enquire whether it contains knowledge about specific properties of the mobile communication device (including, but not limited to display size, resolution, number of colours, ability to display graphics, sound abilities, and ability to play back movies) and to retrieve preferred user topic areas (including, but not limited to trivia/general knowledge, sports, movies, etc., or a custom site).

In the question analysis process, this information from a profile store is used for refinement of the query construction to bias it towards the user's preferred areas and likewise to bias the candidate answer extraction and validation towards the preferred area, optionally using a previously expressed order of priority of interest in a set of topic areas.

In step 630, a search engine query or a set of search engine queries can also be constructed based on the determined question type and the extracted keywords/key phrases, taking into account individual preferences. E.g., the user may want to set his profile to restrict his search to the football domain only during the world cup season (so that only football Web sites and Web services get targeted). Or, he or she may want to simply express that interest in fashion takes priority over financial information, to the effect that answers about questions are not sought from financial Web sites or services.

In addition, special searches of specific sites may be performed based on topic-area information retrieved from the user profile. The phrases or keywords thus extracted or formed are converted into a search engine or information retrieval query, taking into account idiosyncrasies of the search engine/information retrieval engine's syntax (e.g. special operators like “+” to ensure certain words must occur in pages “+football −law”).

In step 650, the candidate answer extraction and validation step, user preferences and favorites are also taken into account: for instance, a user whose User Profile reflects prior expression of strong interest in the sports domain and express lack of interest of the politics domain, documents from the former domain are sought and documents from the latter domain are avoided for retrieval in Query Construction (step 630) by adding to or removing from the query elements that are indicative of the respective domain. Accordingly, candidate answers from contexts that indicating the sports domain and the politics domain, are promoted and demoted in rank, respectively.

In step 660, the answer summary composition step, the predetermined size to which output is to be limited is derived from information about the type and model of the mobile device itself as stored in the user's profile.

Based on the above information, an answer summary that is optimized for the mobile device, using the caller ID that the user sent the question in from to identify his or her profile record. Depending on the preferred or technically limited (e.g. in the case of SMS) maximal message size of the mobile device as retrieved from the user profile s, and the number of retrieved candidate answer fragments n that exceed a minimal confidence threshold, a number c=f(s, n) of candidate answers A1, A2, . . . , AN 215 are considered by the Answer Summary Composition module 216, and merged together, possibly formatted or separated by a special sign (such as a line or a separator character like ‘/’) to form an answer summary 217.

Additionally, the properties of the user's mobile communication device as maintained in the user profile may be used in the answer summary composition to create a summary that uses the capabilities of the mobile communication device: for instance, in one possible embodiment of the invention, if the mobile user's mobile communication device is equipped with a color display, then important parts of the answer summary (e.g. headlines, phrasal heads of candidate answers) can be displayed in a different color.

Furthermore, depending on the user's profile settings, the resulting answer summary may be rendered as text (potentially containing also images and movies) or as speech (in which case a speech synthesis module is invoked).

Finally, the output is sent to the mobile communication device.

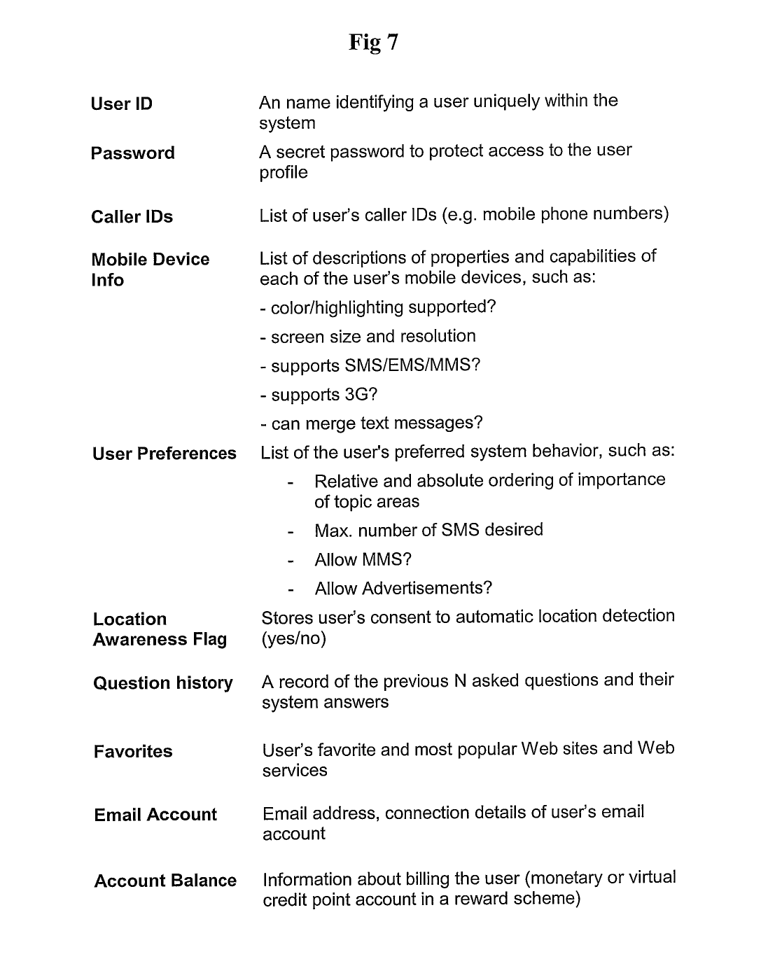

FIG. 7 shows a table with the possible contents of a mobile user profile, comprising parameters specific to the mobile device as well as to the owner of the mobile device.

The user profile stores data pertaining to the identification of the user and his or her mobile communication device, authentification, and a set of properties that are utilized to fine-tune the mobile information access server's behavior to the user.

A user identifier (User ID) is used to distinguish from each other uniquely in the Mobile information access server. A secret password (Password) restricts access of a user's profile at a Web-based User Profile maintenance GUI to the user himself or herself. A list of the features identifying the user (Caller Id) are maintained, including, but not limited to the users caller Ids, e.g. mobile phone numbers, which are used as a key when retrieving user information from the User Profile. Properties and capabilities of the user's mobile devices are maintained in a store (Mobile Device Info), including whether or not features like color or highlighting are supported, the size and resolution of the screen, whether or not the mobile communication device supports SMS, EMS and MMS, respectively, whether it is a 3G phone, whether it is able to merge multiple text messages in one. A list of preferences (User Preferences) stores the user's preferred system behavior, including, but not limited to the absolute and relative ordering of importance of topic areas, the maximum number of answer messages (e.g. max. number of SMS) desired, whether sending MMS is considered appropriate, and whether appending advertisements is acceptable to the user.

A Boolean register (Location Awareness Flag) stores whether or not a user has expressed consent to automatic location detection, thus allowing taking into account the user's mobile communication device from which a query was sent to improve the search (location based search). A history of past questions of the user (Question history) allows taking into account previous information needs to improve search results. A list of favorite Web sites and services (Favorites) allows focusing the search on sites more likely to be relevant to the user in general. Information about how to connect to the user's email store (Email Account) allows retrieval from the user's personal information. An Account Balance stores information about billing the user, such as monetary or virtual credit point account in a reward scheme.

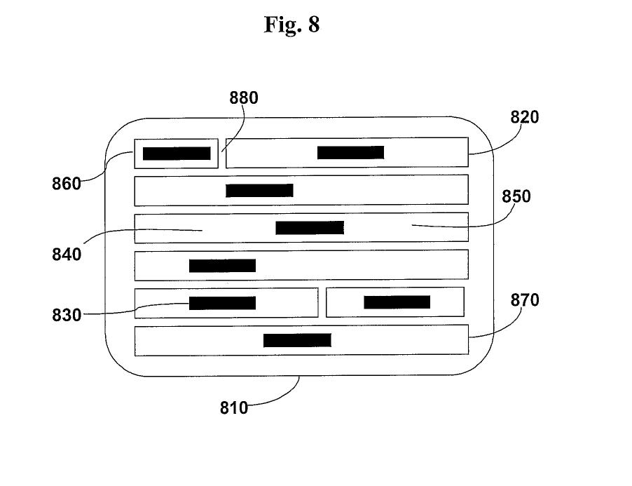

FIG. 8 shows a format of an embodiment of an answer generated by a method for mobile information retrieval according to the invention. The answer summary comprises a set of answer candidate windows (802 to 807), which contain one exact answer candidate each 803, surrounded by left (804) and right (805) context (i.e., text that surrounded the answer candidate in the document where it was found).

In one embodiment, answer candidate windows are separated 808 by a separator sign (such as, but not limited to the character ‘/’) to mark boundaries, to avoid confusing the user. In one embodiment, an answer candidate containing the most likely answer is inserted at initial position 806 without any context in order to ensure that the cut-off after the last answer candidate window 807 does not lead to losing the best answer candidate where the answer may be long.

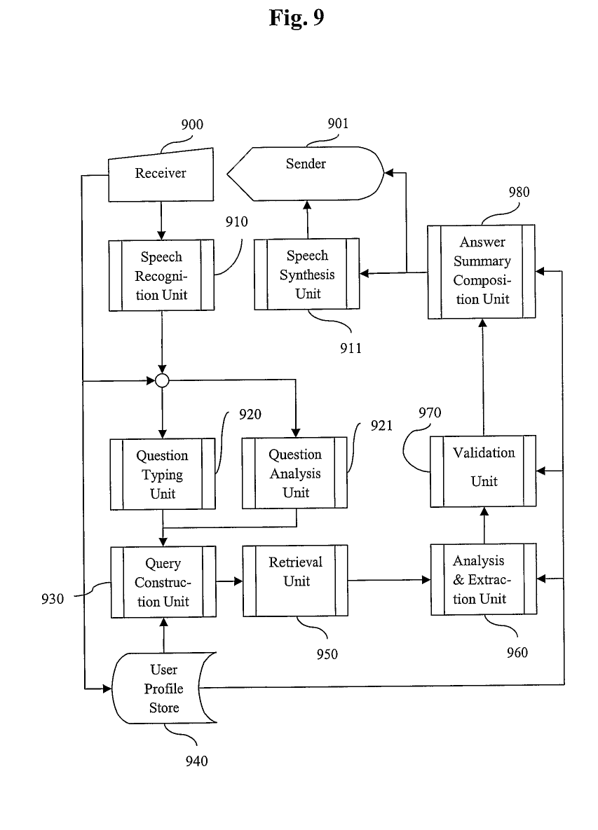

FIG. 9 shows a block diagram of an embodiment of the mobile information access server according to the present invention.

The mobile information access server comprises a receiver 900 for receiving messages from a mobile communication device and a sender 901, which sends messages back to a mobile communication device.

A Speech Recognition Unit 910, a Question Typing Unit 920, a Question Analysis Unit 921, and the input of a User Profile Store 940 are connected to the output of the receiver 900. The Speech Recognition Unit 910 is also connected with the Question Typing Unit 920 and the Question Analysis Unit 921 and the Receiver 900. The output of the Question Typing Unit 920 and the Question Analysis Unit 921 are connected with the Input of a Query Construction Unit 930. The output of the Query Construction Unit is connected to the input of a Retrieval Unit 950.

The output of the User Profile is connected to the input of the Query Construction Unit 930, a Ranking/Validation Unit 970 and an Answer Summary Unit 980.

The output of the Retrieval Unit is connected to the input of a Candidate Answer and Extraction Unit 960. The output of the Candidate Answer and Extraction Unit is connected to the input of the Answer Summary Composition Unit (980). The input of the Answer Summary Composition Unit (980) is connected to the input of a Speech Synthesis Unit (911) and a sender (901). The Speech Synthesis Unit's output is also connected to the sender.

1-15. (canceled)

16. A method of mobile information access, executed in a networked computer system comprising at least a mobile information access server and at least one information retrieval system, comprising the steps of:
receiving a message from a mobile communication device;
analyzing the received message;
forming at least one query based on the message analysis;
obtaining documents based on the query;
extracting candidate answers from the obtained documents;
validating candidate answers;
composing an answer summary; and
sending the answer summary back to the mobile communication device;
wherein the answer summary is limited to a predetermined size.

17. The method of claim 16, wherein the size of the answer summary is limited according to at least one of a maximal display size of the mobile communication device, a maximal message size of a mobile communication protocol, and user preferences.

18. The method of claim 16, wherein the analyzing step comprises the step of extracting a question or a linguistic phrase in natural language from the received message.

19. The method of claim 18, wherein the analyzing step further comprises the step of determining a type and linguistic properties of the question or the linguistic phrase in natural language extracted from the received message.

20. The method of claim 16, further comprising the steps of checking whether the message is received in the form of speech, and if yes, transforming the message from speech to text form by means of automatic speech recognition.

21. The method of claim 19, wherein the forming step includes taking into account whether the extracted question or linguistic phrase refers to a named entity.

22. The method of claim 17, wherein a user is identified automatically and a profile of the user is retrieved based on the identification.

23. The method of claim 22, wherein at least one of the maximal display size of the mobile communication device, the maximal message size of the mobile communication protocol, and individual user preferences is derived from the user profile.

24. The method of claim 22, wherein the forming step includes taking into account information derived from the user profile.

25. The method of claim 22, wherein the extracting step takes into account information derived from the user profile.

26. The method of claim 22, wherein the validating step takes into account information derived from the user profile.

27. The method of claim 22, wherein the composing step takes into account information derived from the user profile.

28. The method of claim 16, wherein the composing step generates an answer summary comprising a set of answer candidate windows which contain one exact answer candidate each, surrounded by left and right context.

29. The method of claim 16, wherein the composing step generates an answer summary in which an answer candidate containing the answer having a highest validation score is inserted at an initial position without any context.

30. An apparatus for mobile information access, comprising:
a unit for receiving a message from a mobile communication device;
a unit for analyzing the received message;
a unit for forming at least one query based on the message analysis;
a unit for obtaining documents based on the query;
a unit for extracting candidate answers from the obtained documents;
a unit for validating candidate answers;
a unit for composing an answer summary, wherein the answer summary is limited to a predetermined size; and
a unit for sending the answer summary back to the mobile communication device.
